(19) United States
(12) Patent Application Publication
(10) Pub. No.: US 2012/0143774 A1
(43) Pub. Date: Jun. 7, 2012

(54) Techniques for Creating Service Status Abstraction Layers Based on Client Roles in a Business Process Management Scenario

(75) Inventors: Francisco Phelan Curbera, Hastings on Hudson, NY (US); Michael John Dikun, Wantagh, NY (US); Yurdaer Nezihi Doganata, Chestnut Ridge, NY (US); Jim Alain Laredo, Katonah, NY (US); John J. Rofrano, Mahopac, NY (US); Zon-yin Shae, South Salem, NY (US); Aleksander Slominski, Riverdale, NY (US)

(73) Assignee: International Business Machines Corporation, Armonk, NY (US)

(21) Appl. No.: 12/961,978

(22) Filed: Dec. 7, 2010

(51) Int. Cl. G06Q 10/00

(52) U.S. Cl. 705/304

(57) ABSTRACT

Techniques for role-based service operation status reporting to clients are provided. In one aspect, a method for reporting a status of a service operation to a client is provided. The method includes the following steps. A sequence of business process steps involved in performing the service operation is identified. One or more abstractions of the business process steps are made, each abstraction containing a sequence of a fewer number of steps than the business process, wherein the number of steps in each of the abstractions correlates with a level of detail about the service operation. The status of the service operation is reported to the client based on a given one of the abstractions having the level of detail best suited to a role of the client.

### FIELD OF THE INVENTION

The present invention relates to business process management systems and more particularly, to techniques for role-based service operation status reporting to clients.

### BACKGROUND OF THE INVENTION

Service providers deploy processes to serve their clients (customers) more effectively. The operational details of these business processes such as how they are executed and interact with each other are, however, not relevant for the clients. In general, clients would like to receive information about their service requests or orders to be able to make better decisions and predictions. For a discussion of process mining, see, for example, Medeiros et al., “ProM Framework Tutorial,” Eindhoven, The Netherlands (February 2008). See also, U.S. Patent Application Publication No. 2010/0114629 filed by Adler et al., entitled “Extracting Enterprise Information Through Analysis of Provenance Data.”

Operational details contain too much detail for clients to process and make decisions, hence there is a need to extract relevant information from the underlying business processes. While the information that is useful for clients depends on the underlying business processes, there exists no formal mapping between the information requested by the clients and the business processes.

The known solutions to this problem include interaction with customer service representatives to learn the status and/or embed predefined status check points within the business process implementation as in the case of order tracking systems provided by postal services. Service-tracking software is available from IssueTrak, Inc., Virginia Beach, Va. The main drawbacks of these existing solutions are that customer service representatives may not have enough information about the details of the existing business operations to satisfy all customer requests. Predefined status check points are static and not flexible enough to satisfy different clients.

Thus, techniques for abstracting operational details at different levels based on how much clients want to know about their request, such as the status of an order, would be desirable.

### SUMMARY OF THE INVENTION

The present invention provides techniques for role-based service operation status reporting to clients. In one aspect of the invention, a method for reporting a status of a service operation to a client is provided. The method includes the following steps. A sequence of business process steps involved in performing the service operation is identified. One or more abstractions of the business process steps are made, each abstraction containing a sequence of a fewer number of steps than the business process steps, wherein the number of steps in each of the abstractions correlates with a level of detail about the service operation. The status of the service operation is reported to the client based on a given one of the abstractions having the level of detail best suited to a role of the client.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for reporting the status of a service operation to a client according to an embodiment of the present invention;

FIG. 2 is a diagram illustrating a core abstraction layer containing the business process steps for an exemplary service operation according to an embodiment of the present invention;

FIG. 3 is a chart illustrating an example of service status abstraction from a business process management layer according to an embodiment of the present invention;

FIG. 4 is a chart illustrating another example of service status abstraction from a business process management layer according to an embodiment of the present invention;

FIG. 5 is a schematic diagram illustrating an exemplary system for reporting the status of a service operation to a client and the possible actions the client may take based on the reported status of the service operation according to an embodiment of the present invention;

FIG. 6 is a table containing exemplary role-based status messages returned in response to a status request by a client when the client proposal review process is in progress according to an embodiment of the present invention; and

FIG. 7 is a diagram illustrating an exemplary apparatus for implementing one or more of the methodologies presented herein according to an embodiment of the present invention.

### DETAILED DESCRIPTION OF PREFERRED EMBODIMENTS

As highlighted above, when a client (customer) requests a service from a service provider, the client typically wants to know the progress (or status) of the service throughout the process, i.e., whether the requested service has been completed or, if in progress, at what stage it is. Presented herein are techniques that permit a service provider to report the status of a service request to the client with a level of detail tailored to the interests of that particular client. Thus, with this process, clients will not be provided with information that is not useful to them. Namely, most clients just want a high level status of the business processes involved in completing the requested service that are important to them. The present techniques are directed to this task by making abstractions of business processes based on the role of the person viewing the process and giving that person a view that is appropriate for his/her role.

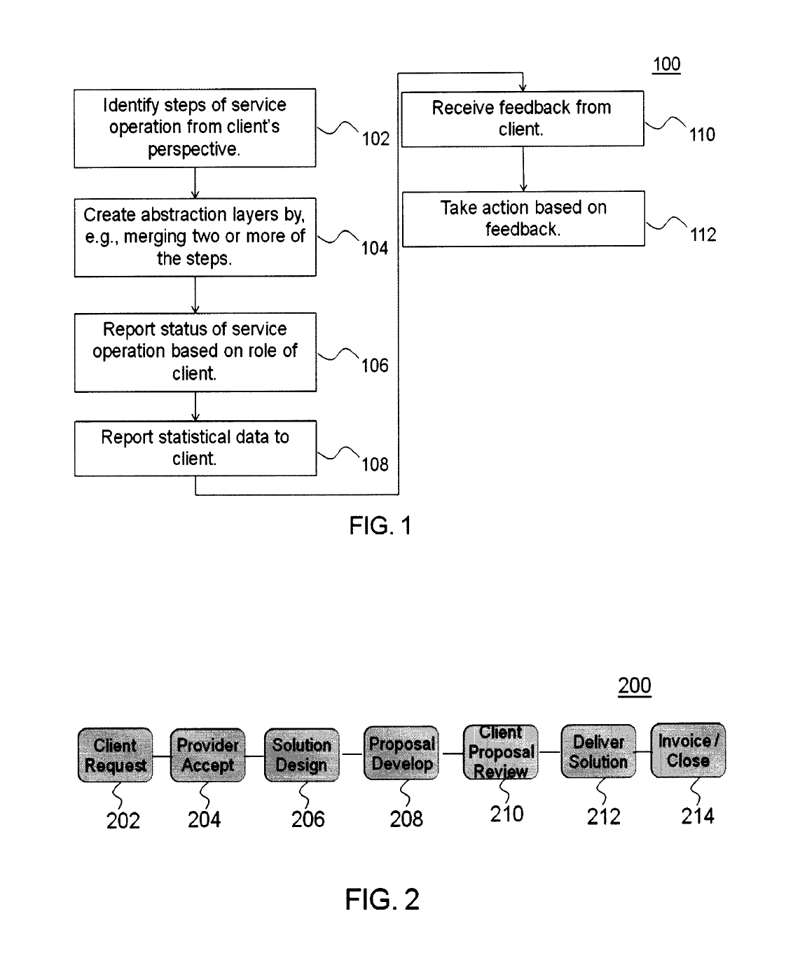

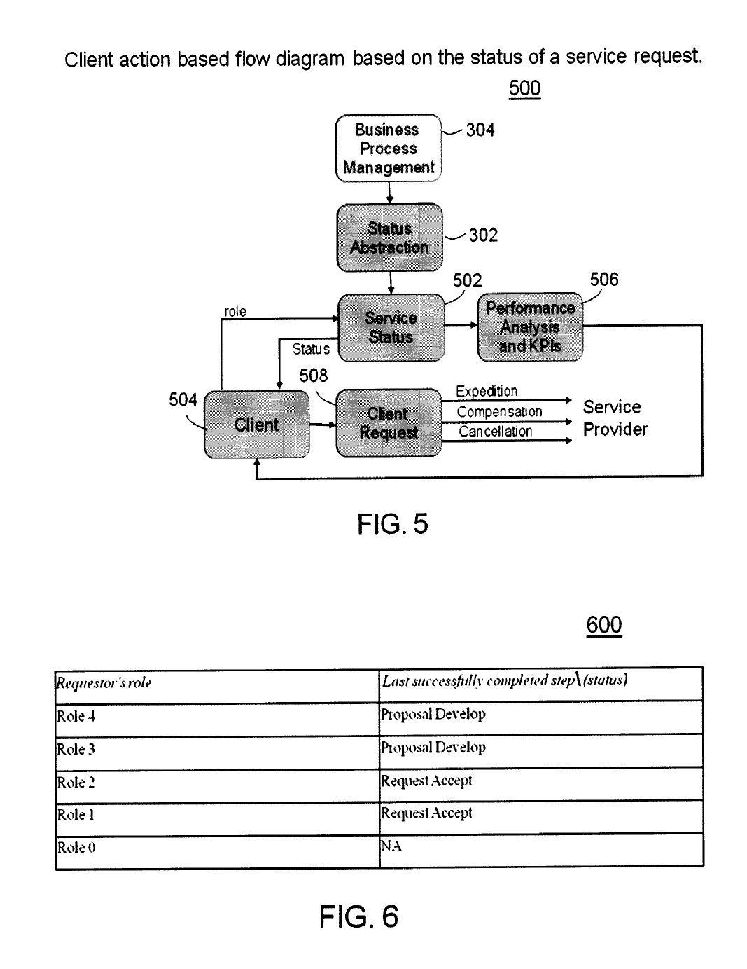

FIG. 1 is a diagram illustrating exemplary methodology 100 for reporting (by a service provider) the status of a service operation to a client. As will be described in detail below, it is assumed in this example that the service operation is being performed by the service provider at the client's request. The client may be a business organization and/or any entity (e.g., a department or an individual) within the organization (see below). Further, methodology 100 is typically performed in response to (or in anticipation of) the client sending an inquiry to the service provider for an update on the status of the operation along with some indicator of the client's role. See, for example, FIG. 5, described below. The client's role, as will be described in detail below, dictates how much detail about the status of the operation is provided to the client.

The term “client,” as used herein, refers generally to any entity that utilizes the services of the service provider and wants a status update on the service. In some cases the term “client” refers broadly to an entire business organization. In most situations, however, the level of interest in the status of a service request varies amongst different entities, e.g., different departments, within the same organization. In that case, the term “client” also refers to the particular department of the organization making the status inquiry. For example, the accounting department of an organization can make a status inquiry for billing purposes. In that case, the accounting department is the client. The information technology (IT) department in the same organization may also make status inquiries perhaps wanting a greater level of detail than the accounting department in order to develop solutions. The IT department would also be considered to be a client. In the same manner, the term “client” can also refer to an individual person. For example, a person with a supervisory role in an organization might him/herself make status inquiries. That person is also considered a client in the context of the present teachings.

Reference is also made herein to “groups” of clients. In a general sense, the groups may consist of any combination of two or more clients, e.g., from within a particular organization and/or amongst several different organizations. By way of example only, the various departments within a particular business organization may constitute a group of clients. As will be described in detail below, clients are grouped, for example, based on their interests in a common level of detail about a particular process. Thus, organizations with a similar business structure and the same service operation might be grouped together, as might the entities (departments/individuals) within those organizations. See description below.

In step 102 (in response to, or in anticipation of, a status inquiry by the client), all of the business process steps involved in the service operation are identified from a perspective of the client. These are the business process steps that are relevant to the client. As an example, the client at hand may not be interested in whether a database is up and running. However, the client would be interested in information accessed from the database if done so in the context of the client's service request. Thus, in most instances the focus from the perspective of the service provider (who is responsible for the maintenance of the business process) is wider than that of the client. As provided above, the term “client” refers to a business organization and/or any entity(ies) within the organization wanting to know the status of a service operation. While these clients might be interested in differing levels of detail about the status of the process, they all share a common perspective on the process. Thus, the term “client perspective” reflects the business process steps for performing the service operation from the client-side of the operation as compared, for example, to that of the service provider.

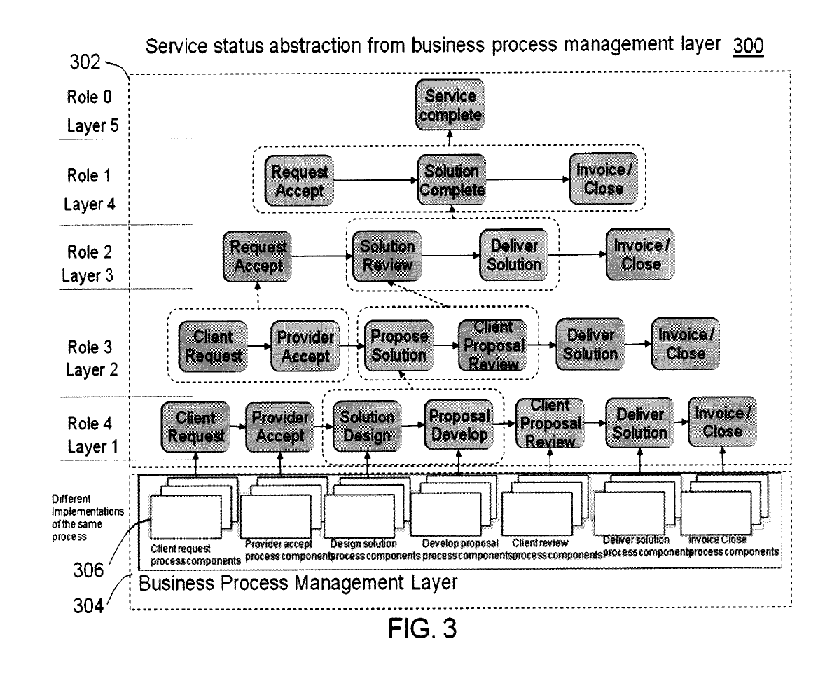

As will be described in detail below, the business process may include steps ranging from receiving the client's request for service all the way to invoicing the client and closing the process, with all of the steps for completing the service request occurring in between. See, for example, FIG. 3, described below. The steps of the business process are generally viewed in a sequential order from the start (initiation) of the service to its completion. Even though the steps are viewed in a sequential order, there may be instances where the business process steps are not performed in sequence (for instance when two or more steps are performed at the same time, i.e., in parallel). In that instance, when a step is completed it is not necessarily the case that, for example, the immediately preceding step in the sequence has also been completed if, e.g., these steps are being performed in parallel. Advantageously, with the present techniques information can be provided to the client as to what business process steps have (or have not yet) been completed, thus making it immaterial whether the steps are performed in sequence or not. See below.

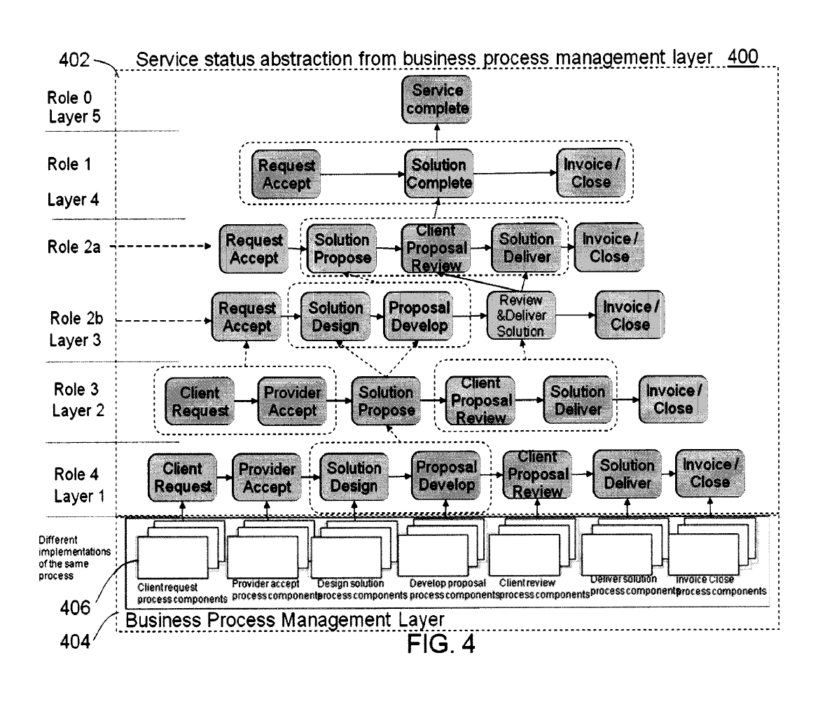

In step 104, one or more abstractions of the business process are made, each abstraction having a varying level of detail about the business process and thus being suited for a particular client role. For example, clients wanting more detail about the process are given a status report (in step 106, below) based on a more detailed abstraction than those clients wanting merely a broad overview of the process. These abstractions are also referred to herein as “abstraction layers” since (as can be seen from FIGS. 3 and 4, described below) it is helpful to arrange the various abstractions in a stacked format with each abstraction making up a layer of the stack. The most detailed abstraction is at the bottom and the least detailed at the top of the stack.

The abstractions are made by merging two or more of the steps of the business process starting from the steps of the overall business process (identified in step 102) and then merging and/or splitting steps from each abstraction to the next. Basically, two or more steps of the overall business process (identified in step 102) are merged to create one or more other abstractions. See for example FIG. 3, described below. Depending on the requirements of a given client role, steps merged in one abstraction might be split in a subsequent abstraction, while for example, other steps are merged. See, for example, FIG. 4, described below. That way the detail hidden by a merging of steps can be made available (i.e., by splitting the merged steps) in another abstraction(s) should it be desired. FIG. 3 illustrates abstractions created solely by merging steps, while FIG. 4 illustrates abstractions created both by merging and splitting steps. Both are described below.

It is notable that the abstraction from the steps identified in step 102 is also referred to herein as the “core abstraction layer” since this is typically the most detailed layer (corresponding to those clients with supervision responsibilities that want a very active role in the operation process) from which all of the other abstractions are made. An exemplary core abstraction layer is shown in FIG. 2, described below. Thus, each abstraction contains enough details of the status of the service operation associated with a role of the client.

In general, in a typical service scenario, the client and the service provider enter into a service contract (also commonly referred to as a service level agreement). A given service provider will enter into service contracts with multiple clients, or groups of clients for which the service provider provides a service(s). Thus, service level agreements are often defined at multiple levels, each level addressing a different group of clients for which, in some cases, the same services are provided.

By way of example only, in one exemplary embodiment, the steps present in the core abstraction layer are determined from the service contract the service provider has with a given client. Specifically, the client (in the service contract) specifies the status information that will be made visible to them. Based on this specification, the core abstraction layer can be built. The service provider will then determine the abstraction layers depending on the status information demanded by the client and the associated roles. As highlighted above, the service contracts are often defined at multiple levels, each level addressing a different group of clients. In that instance, the service provider might make parallel abstraction layers for different client(s) or groups of clients. For example, the service provider might be providing the same service for several different groups of clients. Thus the underlying business process would be the same for each group of clients. However, the service contracts the service provider has with each group of clients might specify different status information each group wants to be made visible. Thus, the abstraction layers the service provider makes for each group of clients will likely be different. Accordingly, multiple abstraction layers will exist in parallel (e.g., abstraction layers 1A, 2A, 3A, etc. for client A, abstraction layers 1B, 2B, 3B, etc. for client B and so on all for the same underlying business process).

Like with the business process in general, each abstraction contains one or more abstracted steps of the business process for performing the service in a sequential order. For example, the overall business process might involve 7 steps. Each abstraction may contain successively fewer steps. For example, an abstraction X might contain 6 steps. A successive abstraction Y (based, e.g., on merging two of the steps in abstraction X) will thus contain only 5 steps. This concept is described in further detail for example in conjunction with the description of FIG. 3, below. It is also possible, according to the present techniques, for two abstraction layers to have the same number of steps. For example, a successive abstraction Z (based, e.g., on merging two of the steps in abstraction Y) might also have 5 steps if for example, another step in abstraction Y (which was created by merging two of the steps from abstraction X) is split again into two separate steps in abstraction Z. Since two steps are merged, but one step is being split into two, the total number of steps remains the same.

As highlighted above, even though the steps in each abstraction are in a sequential order, there may be instances where the underlying business process steps are not performed in sequence (for instance when two or more steps are performed at the same time, i.e., in parallel). In other words, an abstraction step encapsulates multiple business process steps connected to each other in various fashions. The status report to the client (step 106, described below) may, optionally, contain information that lets the client know what underlying process steps have been completed, whether in sequence or not.

In step 106, the service provider reports the status of the service operation to the client based on the abstraction best suited to the role of the client. For example, given the client's role, the service provider finds the abstraction best suited to that role and reports to the client the last completed step in that abstraction. To use a general example, as highlighted above, each abstraction contains one or more abstracted steps of the business process in a sequential order. Thus, if abstraction X which contains steps X₁-X₆ is best suited to the client's role, then the last completed step (X₁-X₆) is reported to the client. Further, say that the last completed step is step X₃ and say that step X₃ is the product of merging two steps from an abstraction having greater detail, then this client would not be given the status that X₃ is complete until (unknown to the client) both of those merged steps have been completed. See also FIG. 6, described below.

The client may also want to know (at the point of status inquiry) what underlying business processes have (or have not yet) been completed. This is especially useful in instances when multiple steps are being performed at the same time, i.e., in parallel. Thus, the status report to the client might also contain, in addition to the last completed step in the appropriate abstraction, a list of all the underlying business process steps completed up to that point. This additional information can be provided at the client's request. A client may or may not want this level of detail about the process.

A client role is defined based on the specific deliverables defined in the service contract between the service provider and the client, clients or groups of clients. The service provider may also define roles in order to monitor the performance of the service being delivered (i.e., the service provider may also monitor its own progress). Thus, a particular client's role can be assigned by the service provider, by the client and/or by the organization of which the client is a part. A client's role can be assigned, for example, at the inception of the business dealings between the service provider and the client and may in fact be specified in the service contract between the parties (i.e., the service provider and the client agree on the particular roles involved). Thus, this step of assigning client roles would occur prior to step 102. This sequence is however not required and the role assigning process can be carried out at any point throughout methodology 100. Say for example, that the client roles are specified in the service contract, but later clients' interests change and/or new clients are added. The service provider or the client can subsequently change/assign new roles to accommodate for these variables.

Optionally, in step 108, the service provider can report additional information regarding the service operation to the client. For example, the service provider can provide the client with information about how long each step took and statistic deviations, i.e., how much it statistically deviated from the norms.

Based on the reported status/statistical information, the client can interact with the service provider. For example, if the reported status is unacceptable to the client, the client can provide feedback to the service provider and ask for expedition, cancellation or compensation. This aspect is described, for example, in conjunction with the description of FIG. 5, below. Thus, in step 110, the service provider can receive the feedback from the client, and in step 112 take action to, e.g., expedite, cancel or compensate the client. Taking action may require intervention at the business process level. For example, the service provider can check the associated activities where the process is stalled or delayed and identify, e.g., the IT level system components that execute these activities. Expedition of the order may require increasing resources or assigning the tasks to other resources through intervention at the IT level.

The process described herein can be used to dynamically build an abstraction layer based on the role of the user (see the description of FIG. 3 and FIG. 4, below). This abstraction describes the business process at a level that is meaningful to someone in that role and hides any details that are unimportant to that role. Through this role-based mechanism, multiple abstractions can be built and optimized to expose only the business process steps relevant for those roles. This has an advantage over static solutions in that users can define the steps that are meaningful to them regardless of how the business defines the process.

FIG. 2 is a diagram illustrating a core abstraction layer 200 containing the business process steps for an exemplary service operation. The term “core” refers to the fact that these steps shown in FIG. 2 represent the highest level of detail a client might be provided with, and from which all other abstractions are made. Namely, as highlighted above, two or more of these steps can be merged, as per step 104 of methodology 100, to create one or more other abstractions for differing client roles. As described above, in the abstractions a step may be split into two or more steps so as to uncover details hidden by a previous merging of those steps. Since core abstraction layer 200 represents the most detailed abstraction of the process, it is preferable that no splitting occurs at the level of core abstraction layer 200. Steps merged from core abstraction layer 200 may, however, be split in subsequent abstractions.

As also highlighted above, each abstraction contains one or more abstracted steps of the business process for performing the service in a sequential order. As shown in FIG. 2, a client makes a service operation request to the service provider. See step 202. The client then waits for the service provider to accept the request. See step 204. The service provider then designs a solution to fulfill the request. See step 206. Based on the solution, the service provider develops a proposal and price for the client. See step 208. The service provider has to discuss the proposal/pricing with the client and gain the client's acceptance of those terms. See step 210. If the client accepts the terms, then the service provider delivers the proposed solution. See step 212. Upon delivery of the solution, the service provider invoices the client and the process is closed. See step 214. Using an example, if a particular client's role corresponds to abstraction layer 200 and if the step 206 is the last step that has been completed by the service provider, then when the client makes a status inquiry the service provider reports (as in step 106, of FIG. 1) that a solution has been designed to fulfill the service request. Then if the client is not satisfied with the progress, the client can optionally request expedition, cancellation or compensation.

It is notable that abstraction layer 200 is merely an exemplary embodiment, and there may in fact be more steps than what is shown in FIG. 2. By way of example only, there may be many more steps below this during the design phase, proposal phase, delivery phase, etc. but clients may not want to know all of these details. They just want a high level status of the business processes that are important to them. In this case, abstraction layer 200 already reflects a merging of some of the business process steps of the service operation. As described above, the steps provided in abstraction layer 200 may be further abstracted out (e.g., by merging steps) for more simple requests that do not require some of these basic steps.

FIG. 3 is a chart 300 illustrating an example of service status abstraction from a business process management layer. In chart 300, multiple status abstractions 302 of an underlying business process 304 have been created to expose only the business process steps relevant/appropriate for a variety of different client roles (e.g., Role 0-Role 4). The multiple abstractions are made in series, wherein each abstraction in the series is created by merging steps in the previous (immediately preceding) abstraction in the series. This aspect will be described in detail below. In general however, if for example there is a series of 5 abstraction layers, then the second abstraction layer would be created by merging steps in the first (immediately preceding) abstraction layer in the series, and so on. FIG. 3 illustrates abstraction solely by merging steps. As highlighted above, in addition to merging, abstractions may also be created by splitting, e.g., previously merged, steps into two or more steps. An example of abstractions created by merging and splitting steps is provided in FIG. 4, described below.

At the bottom of chart 300 are boxes 306 that represent multiple, different implementations of the same business process. The fact that there are multiple boxes 306 associated with each step indicates that in disparate systems, there is the possibility that one base process may be implemented in many different ways—different systems, different steps, but with the same business goal. By way of example only, there are multiple ways in which systems might perform the step of making a service operation request by the client, there might be multiple ways by which the service provider accepts the request, and so on. This is indicated by the multiple boxes 306.

As an example, the request from the client is received through a set of business process components labeled as “Client request process components.” Business process components are used to implement service operations. Business process components are generally software components that represent activities and interactions designed to achieve the service goal. A status component indicates if the activities executed by the underlying business processes are completed or not. The implementation of these business process components may change from system to system or from application to application. In this example, the successful completion of a client request is made visible to a client by linking the status of these components to the “Client Request” status component. It is notable however that according to the example shown in FIG. 3, the “Client Request” status component is present only in abstraction layers 1 and 2. Thus only Role 4 and Role 3 clients can access this status information. The status of the “Solution Design” step, on the other hand, is only visible to Role 4 clients.

As described above, the status information for an abstraction step may contain the status information of the activities of underlying business processes. When the status of an abstraction step is queried, the status of underlying activities may be returned as attributes of the status information of the abstraction step. As an example, completion of an abstraction step b may depend on the completion of one of three underlying business tasks, T1 or T2 or T3. The process task that was executed in order to complete step b can be given as one of the attributes of abstraction step b. For example, the status information of step b may be stated as “b is complete, business task executed (attribute of b)=T2.” This feature is useful, for example, in situations where the underlying business process steps are not performed in sequential order.

The arrangement of the abstraction layers in FIG. 3 (e.g., as a pyramid with the most detailed abstraction layer at the bottom and the least detailed abstraction layer at the top of the pyramid) is meant merely to illustrate one possible exemplary configuration and other embodiments may have different visibility requirements. For example, as highlighted above, the abstraction layers the service provider makes for each client or group of clients may be different (based, e.g., on the service contracts the service provider has with these clients). As such, multiple abstraction layers can exist in parallel for different clients. Thus, the abstraction layer 1, abstraction layer 2, etc. shown in FIG. 3 may be for a particular client, or group of clients and other parallel abstraction layers 1 and 2 (not shown) may exist for other clients based on the same underlying business process. This example of parallel abstraction layers is shown illustrated in FIG. 4, described below.

Underlying business processes may contain many activities running sequentially or parallel, interacting with each other and utilizing and/or generating data. The designer of the business processes knows at the end of which activity the requested status information is satisfied and can provide interfaces for the upper layer to plug in the status components of the first abstraction layer. As an example, in order to complete execution of the “Solution Design” step, the service provider prepares a solution document for the proposed solution and stores it into a content management system. Therefore, in order to check the status of “Solution Design” step in abstraction layer 1, the events of the content management system deployed in the underlying IT system are monitored. As soon as the content management system notifies that the solution document for a particular client is stored, then the associated event is propagated to abstraction layer 1 through application programming interfaces. Similarly, business events associated with the steps of abstraction layer 1 are accessed through programming interfaces.

As shown in FIG. 3, the bottom abstraction layer in this example, labeled “Layer 1,” is visible to a Role 4 client. Thus, a client with Role 4 access can view the status of any of the “Client Request,” “Provider Accept,” “Solution Design,” “Proposal Develop,” “Client Proposal Review,” “Deliver Solution” and “Invoice/Close” steps. Incidentally, the bottom layer in this example, layer 1, is the same as the core abstraction layer example given in FIG. 2. Thus, the abstraction layer of FIG. 2 is the ‘core’ abstraction layer for this exemplary configuration.

Above the bottom layer, layer 1, are several levels of abstraction based on clients' roles. The abstraction layers are labeled, from bottom to top, “Layer 1” to “Layer 5.” Each layer is associated with a particular client role. In this exemplary configuration, going from the bottom to the top of the layers, the granularity of the status inquiry into the service process decreases (i.e., the clients' access is constrained as one moves up the abstraction layers). Thus, a Role 4 client has greater access to more of the service operation details, than a Role 3, 2, 1 or 0 client.

The dotted lines in FIG. 3 encircle those steps that are merged (as in step 104 of FIG. 1) into higher level abstractions suited to clients with a coarser level of access. By way of example only, moving from abstraction layer 1 to abstraction layer 2 the steps of “Solution Design” and “Proposal Develop” are merged into a single step “Propose Solution.” Thus, while a Role 4 client can review the status of both the “Solution Design” and “Proposal Develop” steps, a Role 3 client can only attain the status of the “Propose Solution” step. In this example, a Role 4 client has the greatest level of visibility seeing all seven steps in the business process. Even at this level there is a layer of abstraction above the actual systems below. A Role 3 client does not need to know the details behind the “Propose Solution” step so “Solution Design” and “Proposal Develop” are merged into “Propose Solution” leaving only six visible steps.

Service status abstraction from business process management layer mappings are maintained between the actual business process and this higher level abstraction, which is how an abstraction layer is tied to a lower level implementation. This mapping mechanism allows for multiple lower level steps to be mapped into a single higher level step. The first step of the mapping can be defining the semantics of each business task with the associated processes. Roles can be defined as needed. Some examples are customer role, service provider role, third party agent role, etc. Semantic definitions of a task must be relevant to the information needed for a role. Certain tasks may not be relevant at all. So each activity of a process is marked based on its relevancy to different roles. Finally, the appropriate abstraction layers can be built based on the semantic information extracted from the underlying processes.

The IT level implementation has software and hardware components and the “business purpose” of each implementation is determined by defining the semantics of each business task. As an example, a set of IT components may be deployed to send an invoice. “Sending Invoice” is the semantic level description of lower level tasks and a semantic mapping helps to create abstraction. Some of the IT level detail may not have any semantic relevance, such as using a particular port to send a message. These are excluded from the mapping, focusing on the set of IT level details that have meaningful mapping to higher level of abstraction layers.

A Role 2 client has an even more constrained view with only 4 steps. A Role 2 client does not need to know the details behind the “Request Accept” step thus, in the same manner, moving from abstraction layer 2 to abstraction layer 3, the “Client Request” and “Provider Accept” steps are merged into a single step “Request Accept.” According to an exemplary embodiment, whenever steps are merged, the result is a new step, i.e., like above where the “Client Request” and “Provider Accept” steps are merged into a new step “Request Accept.” A step is new based on the fact that the step is different from any of the steps in the previous abstraction layers in the series. Also a Role 2 client does not need to know the details behind the “Solution Review” thus the “Propose Solution” and “Client Proposal Review” steps are merged into a single step “Solution Review.”

As highlighted above, the present techniques can be used to dynamically build abstraction layers based on the role of the user, since the role of the user might change during the service period. As an example, based on the abstractions shown in FIG. 3, if the requirements of status visibility for a Role 2 client change and a Role 2 client is now required to see the status of the “Provider Accept” step, then in abstraction layer 3 the step “Provider Accept” is added after the “Request Accept” step. As a result, the “Client Request” and “Provider Accept” steps are no longer merged. Accordingly, merge decisions change dynamically with the changing requirements of status visibility.

The “Solution Review” and “Deliver Solution” steps are further merged into a single step “Solution Complete.” Thus, as per abstraction layer 4, a Role 1 client has a perception that the business process has only three steps. A Role 0 client has the least amount of visibility. At abstraction layer 5, i.e., the final abstraction in the series of abstractions, there is only one step “Service Complete.” As highlighted above, this abstraction layer 5 is suited for a client role where the client, for example, just wants to know the completion rate of service requests.

As highlighted above, interests in the level of detail about the status of the service can vary amongst different entities (e.g., departments) within the same business organization. Thus, the client in that case is the particular department making the status inquiry. The departments will have different roles, as well, to reflect their differing levels of interest in the details of the process. To illustrate this concept, the following example is provided again using the scenario of an accounting department and an IT department within the same organization, each being interested in the status of a service request. The accounting department may want to know if the service delivery is completed successfully and on time. The payment amount and the time of payment may depend on this information. The role of the accounting department in this example is to make a payment in the right amount. Hence, they only check the status of the “Service Complete” step. The IT department of the same organization, on the other hand, may want to review the proposed solution. Hence the status of the “Solution Design” step is what the IT department needs to know to start working on the proposed solution. Since the role of the IT department is to develop a solution, then the status information they need to know is more detailed than that of the accounting department. Accordingly, the accounting department and the IT department will have different client roles giving them access to different levels of detail regarding the service request.

FIG. 4 is a chart 400 illustrating another example of service status abstraction from a business process management layer. In chart 400, multiple status abstractions 402 of an underlying business process 404 have been created to expose only the business process steps relevant/appropriate for a variety of different client roles (e.g., Role 0-Role 4). The multiple abstractions are made in series, wherein each abstraction in the series is created by merging and/or splitting previously merged steps in the immediately preceding abstraction in the series. In contrast to FIG. 3, FIG. 4 illustrates abstractions that contain both merged and split steps. As a result, in this example, some abstractions end up having the same number of steps (see, for example, parallel abstraction layer 3 for client roles 2a and 2b). This is a result of a combination of merging and splitting steps within the same abstraction so, in the end, the total number of steps (from one abstraction to the next) remains the same.

At the bottom of chart 400 are boxes 406 that represent multiple, different implementations of the same business process. The fact that there are multiple boxes 406 associated with each step indicates that in disparate systems, there is the possibility that one base process may be implemented in many different ways—different systems, different steps, but with the same business goal. By way of example only, there are multiple ways in which systems might perform the step of making a service operation request by the client, there might be multiple ways by which the service provider accepts the request, and so on. This is indicated by the multiple boxes 406.

The arrangement of the abstraction layers in FIG. 4 is meant merely to illustrate one possible exemplary configuration and other embodiments may have different visibility requirements. For example, as highlighted above, the abstraction layers the service provider makes for each client or group of clients may be different (based, e.g., on the service contracts the service provider has with these clients). As such, multiple abstraction layers can exist in parallel for different clients based on the same underlying business process. To illustrate this situation, in FIG. 4 parallel abstractions are shown for abstraction layer 3, one corresponding to client role 2a and one corresponding to client role 2b.

As shown in FIG. 4, the bottom abstraction layer in this example, labeled “Layer 1,” is visible to a Role 4 client. Thus, a client with Role 4 access can view the status of any of the “Client Request,” “Provider Accept,” “Solution Design,” “Proposal Develop,” “Client Proposal Review,” “Solution Deliver” and “Invoice/Close” steps. Incidentally, the bottom layer in this example, layer 1, is the same as the core abstraction layer example given in FIG. 2. Thus, the abstraction layer of FIG. 2 is the ‘core’ abstraction layer for this exemplary configuration.

Above the bottom layer, layer 1, are several levels of abstraction based on clients' roles. The abstraction layers are labeled, from bottom to top, “Layer 1” to “Layer 5.” Each layer is associated with a particular client role. By contrast with the embodiment illustrated in FIG. 3, in this example both merges and splits are employed in the abstraction. Therefore, it may be possible for two abstraction layers to have the same level of detail. The parallel abstractions for abstraction layer 3 are an example (i.e., each abstraction layer 3 contains 5 steps). In other words, a lower abstraction layer does not always have greater access to process details than higher levels with the exception of abstraction layer 1. No splitting occurs in abstraction layer 1, thus a Role 4 client always has greater access to more of the service operation details, than a Role 3, 2, 1 or 0 client.

The dotted lines in FIG. 4 encircle those steps that are merged and multiple arrows emerging from the same step (into two or more other steps) indicate step splitting (as in step 104 of FIG. 1). By way of example only, moving from abstraction layer 1 to abstraction layer 2 the steps of “Solution Design” and “Proposal Develop” are merged into a single step “Solution Propose.” Thus, while a Role 4 client can review the status of both the “Solution Design” and “Proposal Develop” steps, a Role 3 client can only attain the status of the “Solution Propose” step. In this example, a Role 4 client has the greatest level of visibility seeing all seven steps in the business process. Even at this level there is a layer of abstraction above the actual systems below. A Role 3 client does not need to know the details behind the “Solution Propose” step so “Solution Design” and “Proposal Develop” are merged into “Solution Propose” leaving only six visible steps. However, moving from abstraction layer 2 to abstraction layer 3 (corresponding to a Role 2b client), the “Solution Propose” step is split (unmerged) back into the “Solution Design” and “Proposal Develop” steps, while the “Client Request” and “Provider Accept” steps are merged into a new “Request Accept” step and the “Client Proposal Review” and “Solution Deliver” steps are merged into a new “Review & Deliver Solution” step.

Service status abstraction from business process management layer mappings and how the present techniques can be used to dynamically build abstraction layers were described above. That description is incorporated herein by reference.

The visibility of process details may change for different roles and there may be multiple abstractions corresponding to different roles at each abstraction layer. As an example, in FIG. 4, two abstractions are illustrated for abstraction layer 3, one for a role 2a client and one for a role 2b client. The “Solution Propose” step created in abstraction layer 2 by merging the “Solution Design” and “Proposal Develop” steps of abstraction layer 1 is split again in abstraction layer 3 for Role 2b clients. The reason for this is that this level of detail is deemed not necessary for a Role 2a client, hence “Solution Design” and “Proposal Develop” steps are merged for Role 2a clients. According to an exemplary embodiment, whenever steps are merged, the result is a new step. A step is new based on the fact that the step is different from any of the steps in the previous abstraction layers in the series. The new step can be split (or unmerged) and the result would be the original steps. For example, moving from abstraction layer 2 to abstraction layer 3 (Role 2b) the “Client Proposal Review” and “Solution Deliver” steps are merged into a new step “Review & Deliver Solution.” When the “Review & Deliver Solution” step is later split (going from abstraction layer 3 Role 2b to Role 2a) it is unmerged back into the “Client Proposal Review” and “Solution Deliver” steps. If split steps are remerged, the result is the original merged step. For example, going from abstraction layer 2 to abstraction layer 3 Role 2b, the step “Solution Propose” is split into “Solution Design” and “Proposal Develop” steps, which are remerged going from abstraction layer 3 Role 2b to Role 2a back to “Solution Propose.”

Moving from abstraction layer 3 role 2a to abstraction layer 4, the “Solution Propose,” “Client Proposal Review” and “Solution Deliver” steps are all merged into a new single step “Solution Complete.” Thus, as per abstraction layer 4, a Role 1 client has a perception that the business process has only three steps. A Role 0 client has the least amount of visibility. At abstraction layer 5, i.e., the final abstraction in the series of abstractions, there is only one step “Service Complete.” As highlighted above, this abstraction layer 5 is suited for a client role where the client, for example, just wants to know the completion rate of service requests.

As highlighted above, based on a status report from the service provider, the client may make certain requests, such as expedition, cancellation or compensation for unsatisfactory progress. FIG. 5, for example, is a schematic diagram illustrating an exemplary system 500 for reporting the status of a service operation to a client and the possible actions the client may take based on the reported status of the service operation. As shown in FIG. 5, system 500 includes a number of different components. Specifically, system 500 includes a business process management component 304, a status abstraction component 302, a service status component 502, a client component 504, a performance analysis and key performance indicators (KPIs) component 506, and a client request component 508. Each of these components can be implemented as software components of system 500.

In FIG. 5, the underlying business process (involved in performing the service operation) at the service-provider end is represented schematically by box 304. The underlying business process is numbered alike in FIGS. 3 and 5 to indicate reference to the same component in each figure. Alternatively, the same underlying business process as in FIG. 4 (i.e., business process 404), or any other business process, may instead be used. As described above, one or more abstractions 302 of the steps of the business process (suited for different client roles) may be made in response to, or in anticipation of, a status inquiry from the client. The abstractions are numbered alike in FIGS. 3 and 5 to indicate reference to the same component in each figure. Alternatively, the same abstractions as in FIG. 4 (i.e., abstractions 402), or any other abstractions from a business process created using the present techniques, may instead be used. These abstractions 302 are fed into a service status component 502. According to an exemplary embodiment, service status component 502 is a software component that takes the role of the client and gives back the status, e.g., in terms of the last completed step in the corresponding abstraction.

As shown in FIG. 5, when a client wants to know the status of a service process, the client sends a status inquiry to the service provider. The status inquiry preferably includes the particular role of the client. In this example, the client sends the request/role information to service status component 502. Service status component 502 keeps track of the status of service requests based on each individual role and interacts with the client component 504. Client component 504 is the software component that allows the client to query status information based on the client's particular role. By way of example only, client component 504 can be implemented as a web-based application.

A status message that contains the last successfully completed step (and any other relevant information) is sent from service status component 502 to the client in response to the status inquiry. As described above, the status message is role dependent. Namely, the abstraction best suited to the client's role is used as a basis for reporting the last completed step. An exemplary role-based status report is shown in FIG. 6, described below.

The service status component 502 also interacts with performance analysis and KPIs component 506. The time it takes at every step and their statistical comparison (e.g., to how long the same step took in the past) are done by performance analysis and KPIs component 506. Information about how long each step took to complete and how much it statistically deviated from the norms are sent to the client by performance analysis and KPIs component 506. Based on this information, the client may decide to send a request to the service provider through client request component 508 to either expedite or cancel the service order. Another possibility is that based on the results of how the service is performing, the client may request compensation for the delayed service delivery (i.e., through client request component 508) from the service provider. All reporting of statuses and metrics are also rolled up into the appropriate abstractions to match the client roles. Namely, the statistics of the status information collected at abstraction layer 1 can be used to drive the statistics of the other abstraction layers. This concept statistically is straight forward since the steps of each abstraction layer may be composed from multiple steps of the prior level (i.e., from a prior abstraction layer in the series). As an example, if the individual performances of steps A and B in one abstraction layer are known and the step C in the upper abstraction layer is the combination of A and B, then the performance of C can be calculated from the statistics of A and B.

FIG. 6 is a table 600 containing exemplary role-based status messages returned in response to a status request by a client when the client proposal review process is in progress. The example shown in FIG. 6 is based on the exemplary process steps and abstractions shown in FIG. 3, described above. As shown in FIG. 6, the client (referred to in FIG. 6 as the requestor) role dictates the level of detail and consequently affects the status reported to the client. For example, from FIG. 6 it is seen that at this point in the process, the last completed step reported to the Role 3 and Role 4 clients is “Proposal Develop” whereas the last completed step reported to the Role 2 and Role 1 clients is “Request Accept.” This is because, due to the lower level of detail for Role 1 and 2 clients, the “Proposal Develop” step is not present. Thus, using the Role 2 client as an example, the “Request Accept” will be reported as the status until the “Solution Review” step has been completed. Since a Role 0 client only wishes to know whether the process has been completed, and since the process is still in progress, no status message is currently available for a Role 0 client. The appropriate status report message is selected from table 600 and reported to the client.

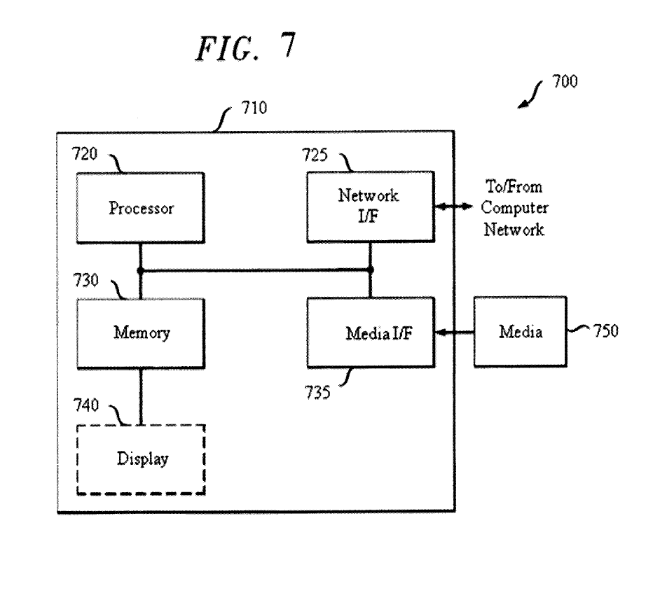

Turning now to FIG. 7, a block diagram is shown of an apparatus 700 for implementing one or more of the methodologies presented herein. By way of example only, apparatus 700 can be configured to implement one or more of the steps of methodology 100 of FIG. 1 for reporting the status of a service operation to a client.

Apparatus 700 comprises a computer system 710 and removable media 750. Computer system 710 comprises a processor device 720, a network interface 725, a memory 730, a media interface 735 and an optional display 740. Network interface 725 allows computer system 710 to connect to a network, while media interface 735 allows computer system 710 to interact with media, such as a hard drive or removable media 750.

As is known in the art, the methods and apparatus discussed herein may be distributed as an article of manufacture that itself comprises a machine-readable medium containing one or more programs which when executed implement embodiments of the present invention. For instance, when apparatus 700 is configured to implement one or more of the steps of methodology 100 the machine-readable medium may contain a program configured to identify a sequence of business process steps involved in performing the service operation; make one or more abstractions of the business process steps, each abstraction containing a sequence of a fewer number of steps than the business process steps, wherein the number of steps in each of the abstractions correlates with a level of detail about the service operation; and report the status of the service operation to the client based on a given one of the abstractions having the level of detail best suited to a role of the client.

The machine-readable medium may be a recordable medium (e.g., floppy disks, hard drive, optical disks such as removable media 750, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 720 can be configured to implement the methods, steps, and functions disclosed herein. The memory 730 could be distributed or local and the processor device 720 could be distributed or singular. The memory 730 could be implemented as an electrical, magnetic or optical memory, or any combination of these or other types of storage devices. Moreover, the term “memory” should be construed broadly enough to encompass any information able to be read from, or written to, an address in the addressable space accessed by processor device 720. With this definition, information on a network, accessible through network interface 725, is still within memory 730 because the processor device 720 can retrieve the information from the network. It should be noted that each distributed processor that makes up processor device 720 generally contains its own addressable memory space. It should also be noted that some or all of computer system 710 can be incorporated into an application-specific or general-use integrated circuit.

Optional video display 740 is any type of video display suitable for interacting with a human user of apparatus 700. Generally, video display 740 is a computer monitor or other similar video display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for reporting a status of a service operation to a client, comprising the steps of:
identifying a sequence of business process steps involved in performing the service operation;
making one or more abstractions of the business process steps, each abstraction containing a sequence of a fewer number of steps than the business process steps, wherein the number of steps in each of the abstractions correlates with a level of detail about the service operation; and
reporting the status of the service operation to the client based on a given one of the abstractions having the level of detail best suited to a role of the client.

2. The method of claim 1, wherein making the one or more abstractions of the business process steps comprises:
merging two or more of the business process steps into one or more single steps.

3. The method of claim 2, further comprising:
splitting one or more previously merged steps into two or more steps.

4. The method of claim 1, wherein making the one or more abstractions of the business process steps comprises:
making a series of the abstractions, wherein each of the abstractions in the series is created by merging two or more of the steps in a previous one of the abstractions in the series into one or more single steps.

5. The method of claim 4, wherein one or more of the abstractions in the series are created by splitting one or more previously merged steps into two or more steps.

6. The method of claim 4, wherein the one or more single steps are different from the steps in any of the previous abstractions in the series.

7. The method of claim 4, wherein a final one of the abstractions in the series contains a single step.

8. The method of claim 7, wherein the single step is that the service operation has been completed.

9. The method of claim 1, wherein reporting the status of the service operation to the client comprises:
reporting to the client a last successfully completed step in the given abstraction.

10. The method of claim 1, further comprising:
reporting to the client at least one of how long each step in the given abstraction took to complete and statistic deviations.

11. The method of claim 1, further comprising:
receiving feedback from the client based on the reported status of the service operation; and
taking action based on the feedback from the client.

12. The method of claim 1, further comprising:
assigning the role to the client.

13. An apparatus for reporting a status of a service operation to a client, the apparatus comprising:
a memory; and
at least one processor device, coupled to the memory, operative to:
identify a sequence of business process steps involved in performing the service operation;
make one or more abstractions of the business process steps, each abstraction containing a sequence of a fewer number of steps than the business process steps, wherein the number of steps in each of the abstractions correlates with a level of detail about the service operation; and
report the status of the service operation to the client based on a given one of the abstractions having the level of detail best suited to a role of the client.

14. The apparatus of claim 13, wherein the at least one processor device when making the one or more abstractions of the business process steps is further operative to:
merge two or more of the business process steps into one or more single steps.

15. The apparatus of claim 13, wherein the at least one processor device when making the one or more abstractions of the business process steps is further operative to:
make a series of the abstractions, wherein each of the abstractions in the series is created by merging two or more of the steps in a previous one of the abstractions in the series into one or more single steps.

16. The apparatus of claim 15, wherein the one or more single steps are different from the steps in any of the previous abstractions in the series.

17. An article of manufacture for reporting a status of a service operation to a client, comprising a machine-readable medium containing one or more programs which when executed implement:
identifying a sequence of business process steps involved in performing the service operation;
making one or more abstractions of the business process steps, each abstraction containing a sequence of a fewer number of steps than the business process steps, wherein the number of steps in each of the abstractions correlates with a level of detail about the service operation; and
reporting the status of the service operation to the client based on a given one of the abstractions having the level of detail best suited to a role of the client.

18. The article of manufacture of claim 17, wherein the one or more programs when making the one or more abstractions of the business process steps implement:
merging two or more of the business process steps into one or more single steps.

19. The article of manufacture of claim 17, wherein the one or more programs when making the one or more abstractions of the business process steps implement:
making a series of the abstractions, wherein each of the abstractions in the series is created by merging two or more of the steps in a previous one of the abstractions in the series into one or more single steps.

20. The article of manufacture of claim 19, wherein the one or more single steps are different from the steps in any of the previous abstractions in the series.
